(19) United States
(12) Patent Application Publication
(10) Pub. No.: US 2026/0009436 A1
(43) Pub. Date: Jan. 8, 2026

(54) ATTACHMENT OF CARBON WEAR LINERS TO CERAMIC MATRIX COMPOSITE (CMC) CORES

(71) Applicant: GOODRICH CORPORATION, Charlotte, NC (US)

(72) Inventors: Matthew Ryan O'Neil, Tipp City, OH (US); Ty Hoglund, Troy, OH (US); Aaron Birman, New Carlisle, OH (US); Scottie G. Whittle, Springboro, OH (US); Christopher T. Kirkpatrick, Pueblo West, CO (US); Brent J. Merritt, Southwick, MA (US)

(73) Assignee: GOODRICH CORPORATION, Charlotte, NC (US)

(21) Appl. No.: 18/761,841

(22) Filed: Jul. 2, 2024

(51) Int. Cl. F16D 65/12; F16D 65/02; F16D 69/04

(52) U.S. Cl. CPC F16D 65/127; F16D 69/0408; F16D 2065/132; F16D 2065/1392; F16D 2069/0433; F16D 2250/0084

(57) ABSTRACT

A friction disk is provided. The friction disk includes a friction disk core, a first wear liner, and a second wear liner. The friction disk core includes at least one of a void through a full thickness of the friction disk core or a first recess in a first face of the friction disk core and a second recess of a second face of the friction disk core. The first wear liner includes a raised portion and a non-raised portion. The second wear liner includes a raised portion and a non-raised portion. The raised portion of the first wear liner is configured to fit within the at least one of the void or the first recess. The raised portion of the second wear liner is configured to fit within the at least one of the void or the second recess.

### FIELD

The present disclosure relates generally to aircraft braking systems and, more specifically, to attachment of carbon wear liners to ceramic matrix composite (CMC) cores.

### BACKGROUND

Aircraft brake systems typically employ a series of friction disks that may be forced into contact with one another to stop the aircraft. The brake system generally includes non-rotating friction disks splined to a non-rotating wheel axle interspersed with rotating friction disks splined to the rotating wheel. The friction disk assemblies may comprise replaceable wear liners coupled to a reusable core. As the wear liners wear (i.e., thin), they may become susceptible to warpage.

### SUMMARY

A friction disk is disclosed, in accordance with various embodiments. The friction disk includes a friction disk core, a first wear liner located over a first surface of the friction disk core, a second wear liner located over a second surface of the friction disk core. The friction disk core includes at least one of a void through a full thickness of the friction disk core or a first recess in a first face of the friction disk core and a second recess of a second face of the friction disk core. The first wear liner includes a raised portion and a non-raised portion. The second wear liner includes a raised portion and a non-raised portion. The raised portion of the first wear liner is configured to fit within the at least one of the void or the first recess on the first face of the friction disk core. The raised portion of the second wear liner is configured to fit within the at least one of the void or the second recess on the second face of the friction disk core.

In various embodiments, the friction disk core includes the void. In various embodiments, the raised portion of the first wear liner mates with the raised portion of the second wear liner within the void in the friction disk core, In various embodiments, the non-raised portion of the first wear liner mates with non-void area of the first face of the friction disk core. In various embodiments, the non-raised portion of the second wear liner mates with non-void area of the second face of the friction disk core.

In various embodiments, the raised portion of the first wear liner that mates with the raised portion of the second wear liner within the void in the friction disk core are coupled together using a C-clip and a rivet.

In various embodiments, the void in the friction disk core is formed from an inner circumferential edge of the friction disk core radially outward through the full thickness of the friction disk core.

In various embodiments, the friction disk core includes at least one first void and at least one second void. In various embodiments, the second wear liner further includes a second wear liner void. In various embodiments, the raised portion of the first wear liner fits through the at least one first void in the friction disk core and the second wear liner void in the second wear liner. In various embodiments, the first wear liner further includes a first wear liner void. In various embodiments, the raised portion of the second wear liner fits through the second void in the friction disk core and the second wear liner void in the first wear liner.

In various embodiments, the first wear liner is coupled to the friction disk core via a first solid pin that is inserted in a first pin hole between the faces of the friction disk core extending from an inner circumferential edge to an outer circumferential edge and into a first hole in the raised portion of the first wear liner. In various embodiments, the second wear liner is coupled to the friction disk core via a second solid pin that is inserted in a second pin hole between the faces of the friction disk core extending from the inner circumferential edge to the outer circumferential edge and into a second hole in the raised portion of the second wear liner.

In various embodiments, the first solid pin is retained within the first pin hole and the first hole in the raised portion of the first wear liner via a first lug clip and a first set of rivets. In various embodiments, the second solid pin is retained within the second pin hole and the second hole in the raised portion of the second wear liner via a second lug clip and a second set of rivets.

In various embodiments, the friction disk core includes the first recess in the first face of the friction disk core and the second recess of the second face of the friction disk core. In various embodiments, the raised portion of the first wear liner mates with the first recess in the first face of the friction disk core. In various embodiments, the raised portion of the second wear liner mates with the second recess in the second face of the friction disk core.

In various embodiments, the raised portion of the first wear liner includes a substantially cylindrical portion formed from an inner circumferential edge of the first wear liner extending radially outward and a set of first tabs extending from the cylindrical portion radially outward. In various embodiments, the raised portion of the second wear liner includes a substantially cylindrical portion formed from an inner circumferential edge of the second wear liner extending radially outward and a set of second tabs extending from the cylindrical portion radially outward.

In various embodiments, the first wear liner and the second wear liner are coupled to the friction disk core via a lug clip fitted over a lug of a set of lugs of the friction disk core, a tab of the set of first tabs of the first wear liner, and a tab of the set of second tabs of the second wear liner. In various embodiments, the lug is coupled to the friction disk core via a set of rivets.

Also disclosed is a friction disk. The friction disk includes a friction disk core, a first wear liner located over a first surface of the friction disk core, a second wear liner located over a second surface of the friction disk core, and a component. The friction disk core includes at least one void through a full thickness of the friction disk core. The first wear liner includes at least one of a first void or a first recess. The second wear liner includes at least one of a second void or a second recess. The component is configured to fit within a void of the at least one void of the friction disk core and into the at least one of the first void or the first recess of the first wear liner and into the at least one of the second void or the second recess of the second wear liner.

In various embodiments, the component is a key ring. In various embodiments, the key ring includes at least one key pin. In various embodiments, the at least one key pin is configured to fit within a void of the at least one void of the friction disk core and into the at least one of the first void or the first recess of the first wear liner and into the at least one of the second void or the second recess of the second wear liner.

In various embodiments, the at least one void of the friction disk core includes a shape. In various embodiments, the shape is at least one of rectangular, substantially rectangular, tapered inward, or tapered outward. In various embodiments, each key pin of the at least one key pin includes a shape. In various embodiments, the shape is at least one of rectangular, substantially rectangular, tapered inward, or tapered outward.

In various embodiments, the key ring is a set of key rings.

In various embodiments, the component is a key pin. In various embodiments, the first wear liner includes only the at least one the first recess. In various embodiments, the second wear liner includes only the at least one second recess. In various embodiments, the key pin is configured to fit within a void of the at least one void of the friction disk core and into the at least one first recess of the first wear liner and into the at least one second recess of the second wear liner.

In various embodiments, the at least one void of the friction disk core includes a shape. In various embodiments, the shape is at least one of rectangular, substantially rectangular, tapered inward, or tapered outward. In various embodiments, the key pin includes a shape. In various embodiments, the shape is at least one of rectangular, substantially rectangular, tapered inward, or tapered outward.

In various embodiments, graphite paint is utilized to couple the friction disk core, the first wear liner, and the second wear liner utilizing the key pin. In various embodiments, once assembled, the friction disk is air dried to cure the graphite paint and secure the key pin to the friction disk core, the first wear liner, and the second wear liner.

In various embodiments, the at least one void is machined through the full thickness of the friction disk core in an area between an inner circumferential edge and an outer circumferential edge of the friction disk core. In various embodiments, the component is at least one of a pin or a puck. In various embodiments, the pin or the puck of the at least one of the pin or the puck is configured to fit within a void of the at least one void of the friction disk core and into the first recess of the at least one first recess of the first wear liner and into a second recess of the second recess of the second wear liner.

In various embodiments, the least one void of the friction disk core is substantially cylindrical. In various embodiments, the first recess of the at least one first recess of the first wear liner is substantially cylindrical. In various embodiments, the second recess of the second recess of the second wear liner is substantially cylindrical. In various embodiments, the at least one of the pin or the puck is substantially cylindrical.

In various embodiments, the first wear liner includes a first plurality of tabs extend radially outward from an outer edge of the first wear liner. In various embodiments, the second wear liner includes a second plurality of tabs extend radially outward from an outer edge of the second wear liner. In various embodiments, the first wear liner and the second wear liner are coupled to the friction disk core via a lug clip fitted over a lug of a set of lugs of the friction disk core, a tab of the first plurality of tabs of the first wear liner, and a tab of the second plurality of tabs of the second wear liner. In various embodiments, the lug is coupled to the friction disk core via a set of rivets.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosures, however, may best be obtained by referring to the detailed description and claims when considered in connection with the drawing figures, wherein like numerals denote like elements.

FIG. 1 illustrates a multi-disk brake system, in accordance with various embodiments.

FIGS. 2A and 2B illustrate an exploded view and a cross section view along line A-A in an unexploded view of a rotor having a friction disk core with wear liners coupled to the friction disk core, in accordance with various embodiments.

FIGS. 3A and 3B illustrate an exploded view and a cross section view along line B-B in an unexploded view of a stator having a friction disk core with wear liners coupled to the friction disk core, in accordance with various embodiments.

FIGS. 4A, 4B, 4C, 4D, 4E, 4F, 4G, 4H, 4I, and 4J illustrate a view of a rotor where wear liners are coupled to the friction disk core using solid pins and lug clips, in accordance with various embodiments.

FIGS. 5A, 5B, and 5C illustrate a portion of a rotor having a friction disk core with wear liners coupled to the friction disk core using a key ring, in accordance with various embodiments.

FIG. 6 illustrates a portion of a stator having a friction disk core with wear liners coupled to the friction disk core using a key ring, in accordance with various embodiments.

FIG. 7 illustrates a portion of a rotor having a friction disk core with wear liners coupled to the friction disk core using key pins, in accordance with various embodiments.

FIG. 8 illustrates an exploded view of a rotor having a friction disk core with wear liners coupled to the friction disk core utilizing a pin or puck along with tabs that that are fitted into slots in the lugs of the friction disk core, in accordance with various embodiments.

FIG. 9 illustrates an exploded view of a rotor having a friction disk core with wear liners coupled to the friction disk core utilizing boss/slot features, in accordance with various embodiments.

### DETAILED DESCRIPTION

The detailed description of embodiments herein makes reference to the accompanying drawings, which show embodiments by way of illustration. While these embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not for limitation. For example, any reference to singular includes plural embodiments, and any reference to more than one component or step may include a singular embodiment or step. Also, any reference to attached, fixed, connected or the like may include permanent, removable, temporary, partial, full and/or any other possible attachment option. Further, any steps in a method discussed herein may be performed in any suitable order or combination.

In the case of components that rotate about a common axis, a first component that is “radially outward” of a second component means that the first component is positioned at a greater distance away from the common axis than the second component. A first component that is “radially inward” of a second component means that the first component is positioned closer to the common axis than the second component. In the case of components that rotate circumferentially about a common axis, a first component that is radially inward of a second component rotates through a circumferentially shorter path than the second component. As used herein, “distal” refers to the direction outward, or generally, away from a reference component. As used herein, “proximate” refers to a direction inward, or generally, towards the reference component.

Carbon/carbon (C/C) composites and silicon carbide (SiC) based ceramic matrix composites (CMCs) have found use in the aerospace and other industries for fabricating brake stacks and heat sinks. These brake stacks or heat sinks may utilize a core-liner concept (CMC core, C/C disk), i.e. friction disk core. Accordingly, brake assemblies of the present disclosure may include friction disks having a friction disk core with carbon wear liners, referred to simply as wear liners hereafter, coupled thereto.

In various embodiments, the wear liners may be coupled to the friction disk core using a boss features, C-clips, and lug clips. In various embodiments, the friction disk core may include slots machined into the friction disk core which are sized based on program requirements. In various embodiments, the slots in the friction disk core are through the full thickness of the friction disk core. In various embodiments, an inwardly facing portion of the wear liners, i.e. a face of each wear liner facing the friction disk core, includes an opposite feature to the slots in the friction disk core, i.e. a boss that extends halfway or substantially halfway through the thickness of each of the wear liners such that the wear liners mate at the center plane of the friction disk core. In various embodiments, once the wear liners are fitted to either side of the friction disk core, a mating portion of the wear liners are fastened together through the use of C-clips and rivets. In various embodiments, once the wear liners are fitted to either side of the friction disk core, the non-mating portion of the wear liners are fastened to the friction disk core using lug clips and rivets. In various embodiments, the C-clips and lug clips function as washers for a riveting process, therefore spreading the load from the rivet head more effectively. In various embodiments, the C-clips are affixed to wear liners on an inside diameter and the lug clips are affixed on an outside diameter for rotors. In various embodiments, the C-clips are affixed to wear liners on an outside diameter and the lug clips are affixed on an inside diameter for stators.

In various embodiments, the wear liners may be coupled to the friction disk core using a solid pins and lug clips. In various embodiments, a radially inserted solid pin will provide axial retention of the wear liners to the friction disk core. In various embodiments, a hole for the pin will start on an outside diameter of the friction disk core for a rotor and extend into a hole in a log of the wear liner. In various embodiments, a hole for the pin will start on an inside diameter of the friction disk core for a stator and extend into a hole in a log of the wear liner. In various embodiments, the hole in the friction disk core will then be covered with a lug. In various embodiments, rotational movement of the wear liners may be prevented through an alternating pattern of wear liner lug clips that are fitted into corresponding friction disk core slots and wear liner slots in the wear liner on the other side of the friction disk core. In that regard, in various embodiments, the ware liner lug clips extend a full thickness of the disk assembly and fit through the slot in the friction disk core and a corresponding slot of the wear liner on the other side of the friction disk core. In various embodiments, the slots in both the friction disk core and the wear liner on the other side of the friction disk core will extend the full thickness of the component.

In various embodiments, the wear liners may be coupled to the friction disk core using a key ring or a key pin. In various embodiments, a key ring, which may be a single key ring or a set of key rings, is coupled to an inside diameter of the friction disk core for a rotor. In various embodiments, a key ring, which may be a single key ring or a set of key rings, is coupled to an outside diameter of the friction disk core for a stator. In various embodiments, the key pins on the key ring protrude into a set of slots in the friction disk core. In various embodiments, the key pins on the key ring may be rectangular or substantially rectangular, tapered inward, or tapered outward, among other configurations. In that regard, in various embodiments, the slots in the friction disk core may be rectangular or substantially rectangular, tapered inward, or tapered outward, among other configurations. In various embodiments, the slots in the friction disk core are through the full thickness of the friction disk core. In various embodiments, the wear liners include a matching slot that extends either through a full thickness of the wear liner or halfway or substantially halfway through the thickness of the wear liner such that a key on the key ring extends through the full thickness of the friction disk core and all the way through each of the wear liner or only halfway or substantially halfway through the each of the wear liners. In various embodiments, the wear liners may then be coupled to the friction disk core and the key ring via cast clips, half cast clips, floating clips, or lug clips, among others. In various embodiments, when only key pins are utilized, i.e. without the ring, the slots in the friction disk core are through the full thickness of the friction disk core and are tapered so that the key pin cannot come out the tapered slot in a radial direction. In various embodiments, when only key pins are utilized the wear liners include a matching tapered slot that extends halfway or substantially halfway through the thickness of the wear liner such that the key pin extends through the full thickness of the friction disk core and halfway or substantially halfway through the each of the wear liners and the wear liners retain the key pin between the wear liners. In various embodiments, the wear liners may then be coupled to the friction disk core and retain the key pins via cast clips, half cast clips, floating clips, or lug clips, among others.

In various embodiments, the wear liners may be coupled to the friction disk core utilizing a pin or puck along with tabs that that are fitted into slots in the lugs of the friction disk core. In various embodiments, the friction disk core may include cylindrical holes machined into the core which are sized based on program requirements. In various embodiments, the cylindrical holes in the friction disk core are through the full thickness of the friction disk core. In various embodiments, an inwardly facing portion of the wear liners, i.e. a face of each wear liner facing the friction disk core, include cylindrical holes that extends halfway or substantially halfway through the thickness of the wear liner. In various embodiments, a cylindrical pin or puck extends through the cylindrical hole in the friction disk core and into cylindrical holes of the wear liners. In various embodiments, the cylindrical pin or puck may be made of a carbon/carbon material or other high temperature material that has good shear properties, such as boron carbide (B4C) or silicon carbide, among others. In various embodiments, the cylindrical pin or puck may be produced in a cross laminar direction, to allow for smaller pins or pucks. In various embodiments, the wear liners have tabs on a radially outward portion of the wear liner for rotor wear liners and on a radially inward portion of the wear liner for stator wear liners. In various embodiments, the tabs extend into slots machined into faces of the lugs of the rotor or stator. In various embodiments, lug clips are then placed over the lugs and wear liner tabs and are affixed to the lugs thereby retaining the wear liners in place.

In various embodiments, the wear liners may be coupled to the friction disk core utilizing boss/slot features. In various embodiments, the friction disk core may include slots machined into the core which are sized based on program requirements. In various embodiments, the slots in the friction disk core extend only partially into the friction disk core. In various embodiments, an inwardly facing portion of the wear liners, i.e. a face of each wear liner facing the friction disk core, include an opposite feature to the slots in the friction disk core, i.e. a boss that extends halfway or substantially halfway through the thickness of the wear liner such that boss of the wear liners mate with the slots in the friction disk core. In various embodiments, the wear liners have tabs on a radially outward portion of the wear liner for rotor wear liners and on a radially inward portion of the wear liner for stator wear liners. In various embodiments, the tabs extend into slots machined into faces of the lugs of the rotor or stator. In various embodiments, lug clips are then placed over the lugs and wear liner tabs and are affixed to the lugs thereby retaining the wear liners in place. In various embodiments, the boss/slot features transfer all torque from the wear liner to the friction disk core.

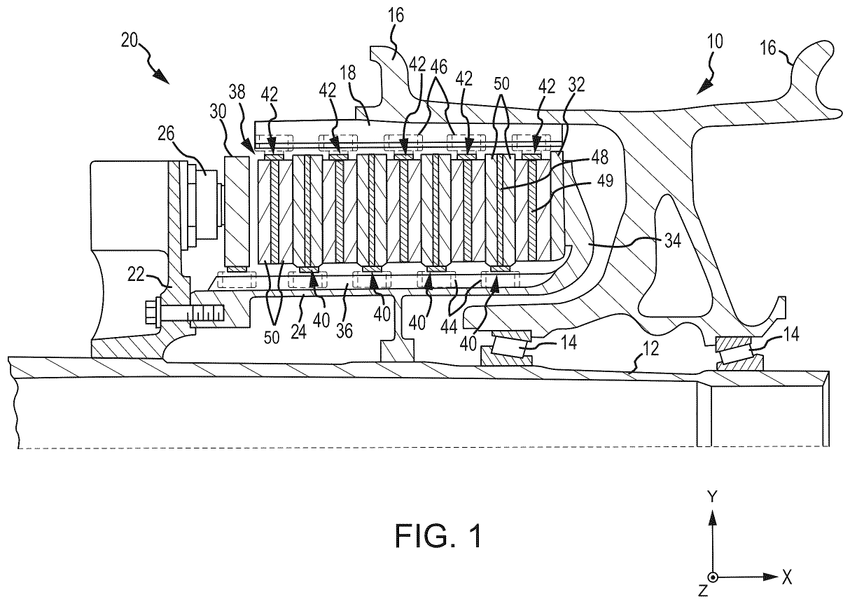

Referring to FIG. 1, in accordance with various embodiments, a multi-disk brake system 20 is illustrated. The system may include a wheel 10 supported for rotation around axle 12 by bearings 14. Axle 12 defines an axis of multi-disk brake system 20 and the various components thereof. Any reference to the terms axis and axial may include an axis of rotation defined by axle 12 or a dimension parallel to such axis. Wheel 10 includes rims 16 for supporting a tire, and a series of axially extending rotor splines 18 (one shown). Rotation of wheel 10 is modulated by multi-disk brake system 20. Multi-disk brake system 20 includes torque flange 22, torque tube 24, a plurality of pistons 26 (one shown), pressure plate 30, and end plate 32. Torque tube 24 may be an elongated annular structure that includes reaction plate 34 and a series of axially extending stator splines 36 (one shown). Reaction plate 34 and stator splines 36 may be integral with torque tube 24, as shown in FIG. 1, or attached as separate components.

Multi-disk brake system 20 also includes a plurality of friction disks 38. The plurality of friction disks 38 includes at least one non-rotatable friction disk (stator) 40, and at least one rotatable friction disk (rotor) 42. Stators 40 may comprise a friction disk core (stator core) 48 and wear liners 50 located over opposing sides of the friction disk core 48. Rotors 42 may comprise a friction disk core (rotor core) 49 and wear liners 50 located over opposing sides of the rotor core 49. Each friction disk of the plurality of friction disks 38 includes an attachment structure. For example, stators 40 include a plurality of stator lugs 44 at circumferentially spaced positions around an inner circumference of stators 40, and rotors 42 include a plurality of rotor lugs 46 at circumferentially spaced positions around an outer circumference of rotors 42.

In various embodiments, pressure plate 30, end plate 32, and wear liners 50 are each annular structures made at least partially from a carbon composite material. In various embodiments, friction disk cores 48, 49 and wear liners 50 may comprise different materials. For example, friction disk cores 48, 49 may comprise a first material, for example, steel for titanium, and wear liners 50 may comprise a second material, for example, a carbon composite material. In various embodiments, friction disk cores 48, 49 and wear liners 50 may comprise the same material. For example, friction disk cores 48, 49 and wear liners 50 may both comprise a carbon composite material. The material of friction disk cores 48, 49 may be selected for its structural properties, thermal conductivity, heat capacity, and/or oxidation resistance properties, and the material of wear liners 50 may be selected for its wear resistance and/or frictional properties. Thus, friction disks 38 may experience the structural advantages of friction disk cores 48, 49 and the frictional advantages of wear liners 50.

Torque flange 22 is mounted to axle 12. Torque tube 24 is bolted to torque flange 22 such that reaction plate 34 is near an axial center of wheel 10. End plate 32 is connected to a surface of reaction plate 34 facing axially away from the axial center of wheel 10. Thus, end plate 32 is non-rotatable by virtue of its connection to torque tube 24. Stator splines 36 may support the pressure plate 30 such that pressure plate 30 is also non-rotatable. Stator splines 36 also support the stators 40. Stators 40 engage stator splines 36 with gaps formed between stator lugs 44. Similarly, rotors 42 engage rotor splines 18 with gaps formed between rotor lugs 46. Thus, rotors 42 are rotatable by virtue of their engagement with rotor splines 18 of wheel 10.

In various embodiments, rotors 42 are arranged with end plate 32 on one end, pressure plate 30 on the other end, and stators 40 interleaved such that rotors 42 are adjacent to non-rotatable friction components. Pistons 26 are connected to torque flange 22 at circumferentially spaced positions around torque flange 22. Pistons 26 face axially toward wheel 10 and contact a side of pressure plate 30 opposite rotors 42. Pistons 26 may be powered electrically, hydraulically, or pneumatically. In response to actuation of pistons 26, a force towards reaction plate 34 is exerted on friction disks 38 such that rotors 42 and stators 40 are pressed together between pressure plate 30 and end plate 32.

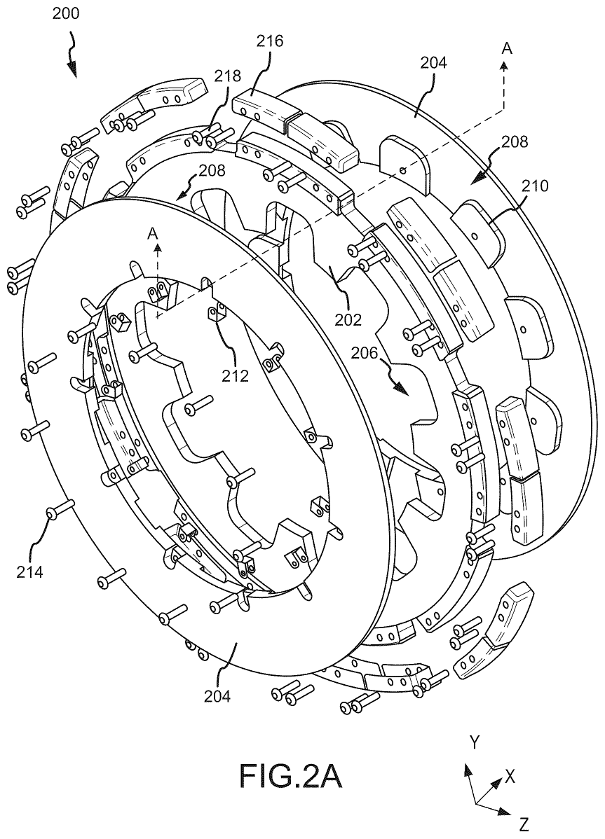

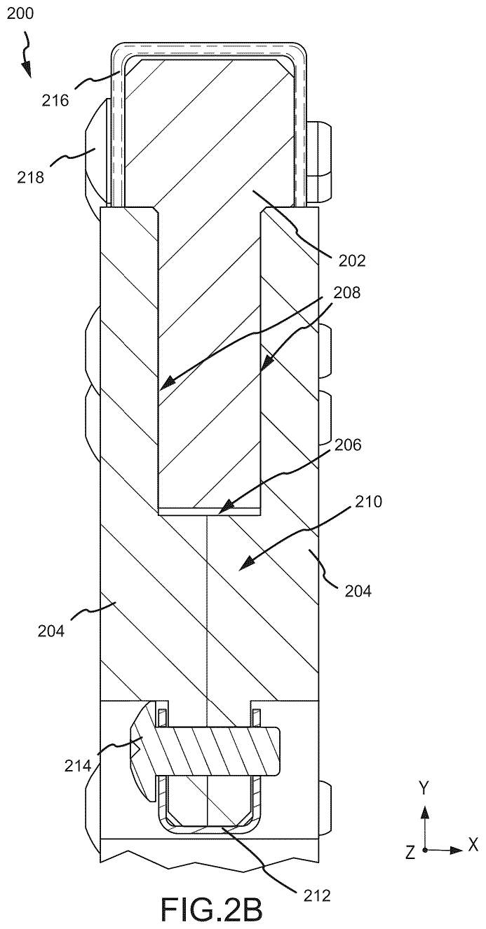

Referring now to FIGS. 2A and 2B, in accordance with various embodiments, an exploded view and a cross section view along line A-A in an unexploded view of a rotor having a friction disk core with wear liners coupled to the friction disk core is illustrated. In various embodiments, rotor 200, which may be a rotor such as a rotor of rotors 42 of FIG. 1, includes a friction disk core 202 and wear liners 204. In various embodiments, the friction disk core 202 includes two faces, an inner circumferential edge, and an outer circumferential edge. In various embodiments, the wear liners 204 include an inner face that faces one of the faces of the friction disk core 202, an outer face, an inner circumferential edge, and an outer circumferential edge. In various embodiments, the friction disk core 202 may include slots 206, i.e. voids, machined into the friction disk core 202 which are sized based on program requirements. In various embodiments, the slots 206 in the friction disk core 202 are formed from the inner circumferential edge radially outward through the full thickness of the friction disk core 202. In various embodiments, a portion of the inwardly facing portion 208 of the wear liners 204, i.e. a portion of the inner face of each of wear liners 204 facing the friction disk core 202, includes an opposite feature to the slots in the friction disk core, i.e. a boss 210, i.e. a raised portion, that is formed from the inner circumferential edge radially outward and extends halfway through the thickness of each of the wear liners 204 such that the bosses 210 of the wear liners 204 mate at the center plane of the friction disk core 202 within the slot 206. In various embodiments, once the wear liners 204 are fitted to either side of the friction disk core 202, a mating portion, i.e. the bosses 210, of the wear liners 204 are fastened together through the use of C-clips 212 and rivets 214. In various embodiments, once the wear liners 204 are fitted to either side of the friction disk core 202, the non-mating portions of the wear liners 204 are fastened to a non-void area of the friction disk core 202 using lug clips 216 and rivets 218. In various embodiments, the C-clips 212 and lug clips 216 function as washers for a riveting process, therefore spreading the load from the rivet head more effectively. In various embodiments, the C-clips 212 are affixed to wear liners 204 on an inside diameter of the rotor 200 and the lug clips 216 are affixed on an outside diameter of the rotor 200.

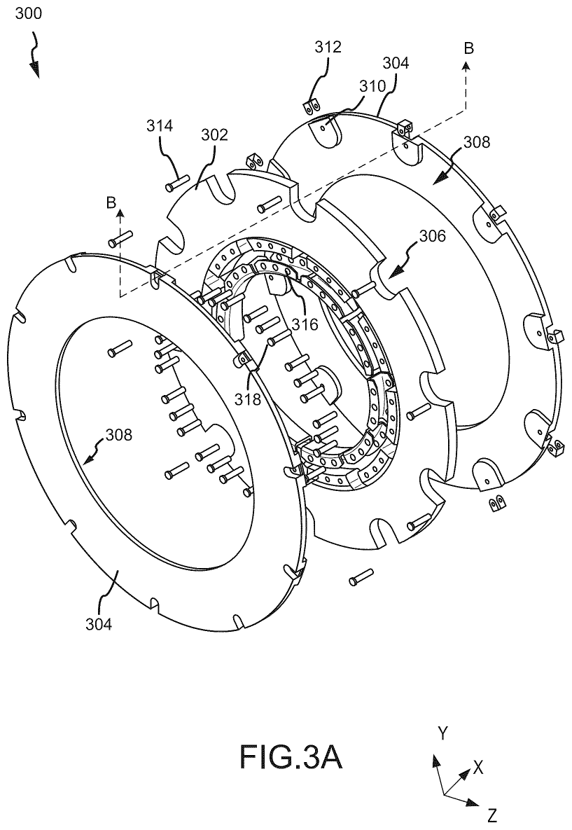

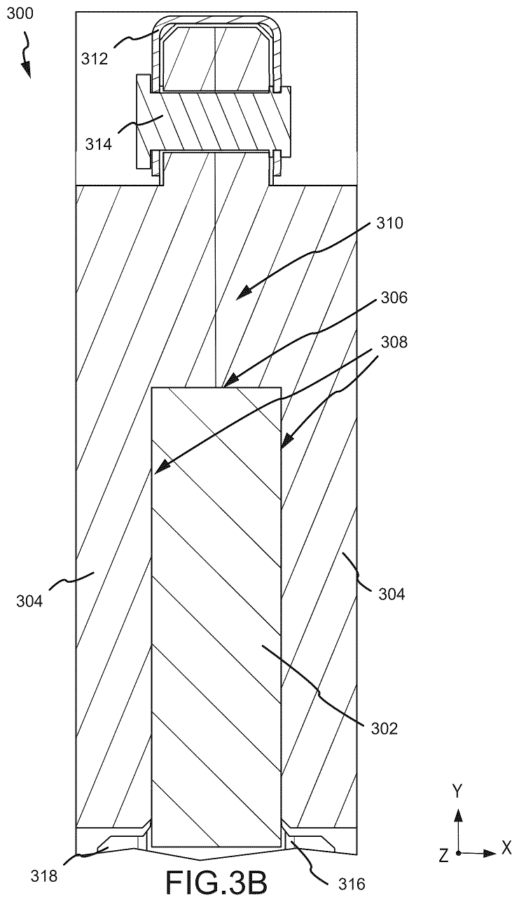

Referring now to FIGS. 3A and 3B, in accordance with various embodiments, an exploded view and a cross section view along line B-B in an unexploded view of a stator having a friction disk core with wear liners coupled to the friction disk core is illustrated. In various embodiments, stator 300, which may be a stator such as a stator of stators 40 of FIG. 1, includes a friction disk core 302 and wear liners 304. In various embodiments, the friction disk core 302 includes a two faces, an inner circumferential edge, and an outer circumferential edge. In various embodiments, the wear liners 304 include an inner face that faces one of the faces of the friction disk core 302, an outer face, an inner circumferential edge, and an outer circumferential edge. In various embodiments, the friction disk core 302 may include slots 306, i.e. voids, machined into the friction disk core 302 which are sized based on program requirements. In various embodiments, the slots 306 in the friction disk core 302 are formed from the inner circumferential edge radially inward through the full thickness of the friction disk core 302. In various embodiments, a portion of the inwardly facing portion 308 of the wear liners 304, i.e. a portion of the inner face of each of wear liners 304 facing the friction disk core 302, includes an opposite feature to the slots in the friction disk core, i.e. a raised feature or a boss 310, i.e. a raised portion, that is formed from the inner circumferential edge radially inward and extends halfway or substantially halfway through the thickness of each of the wear liners 304 such that the bosses 310 of the wear liners 304 mate at the center plane of the friction disk core 302 within the slot 306. In various embodiments, once the wear liners 304 are fitted to either side of the friction disk core 302, a mating portion, i.e. the bosses 310, of the wear liners 304 are fastened together through the use of C-clips 312 and rivets 314. In various embodiments, once the wear liners 304 are fitted to either side of the friction disk core 302, the non-mating portions of the wear liners 304 are fastened to non-void areas of the friction disk core 302 using lug clips 316 and rivets 318. In various embodiments, the C-clips 312 and lug clips 316 function as washers for a riveting process, therefore spreading the load from the rivet head more effectively. In various embodiments, the C-clips 312 are affixed to wear liners 304 on an outside diameter of the stator 300 and the lug clips 316 are affixed on an inside diameter of the stator 300.

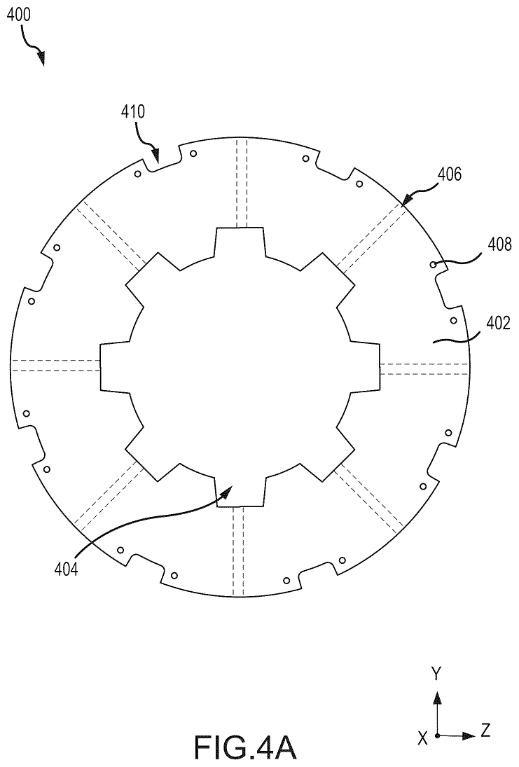

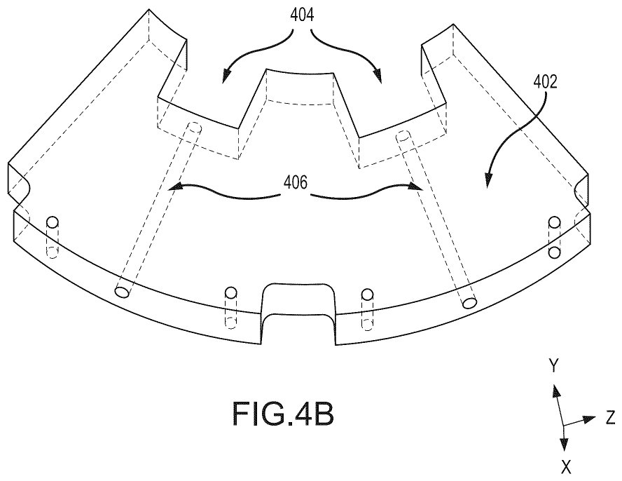

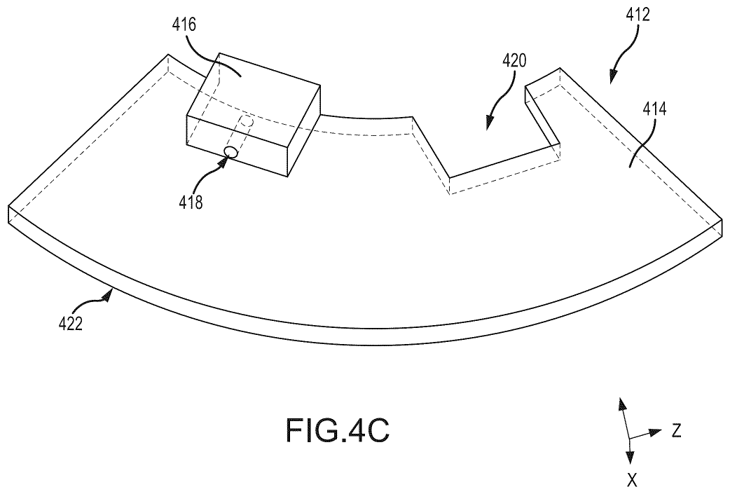

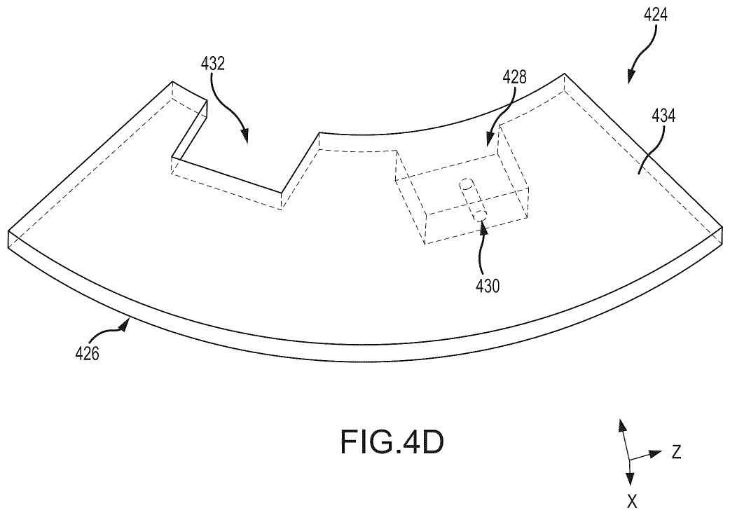

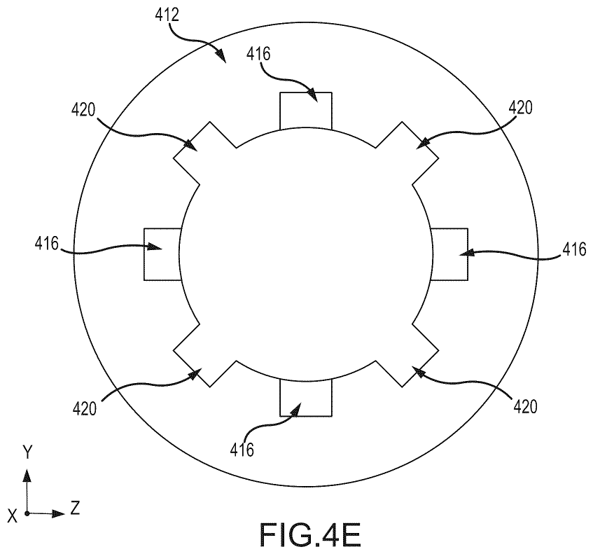

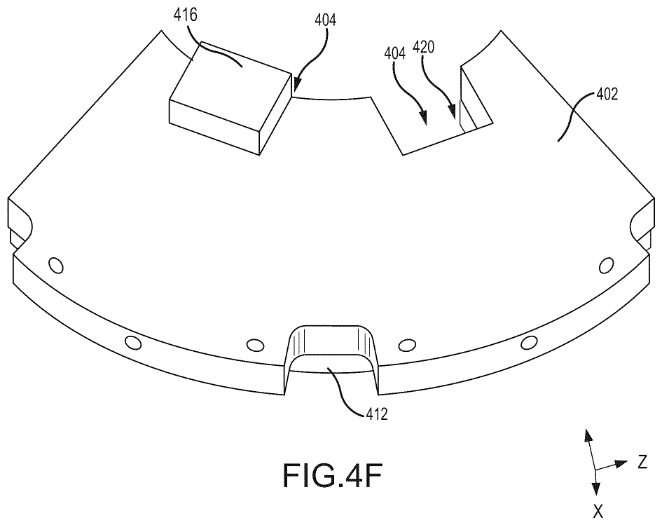

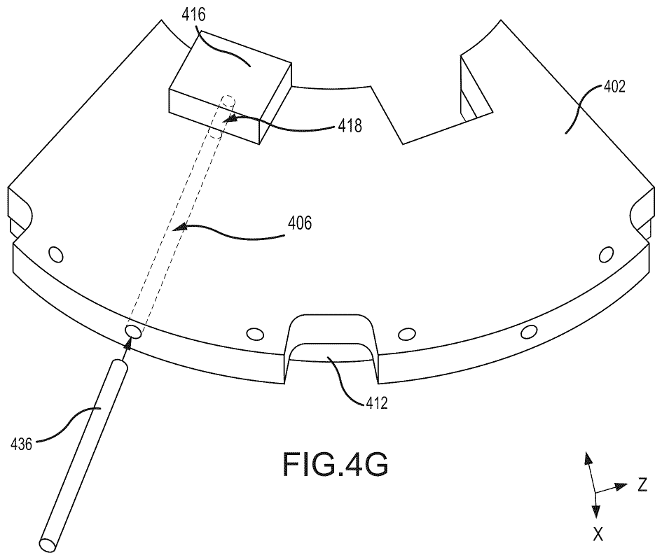

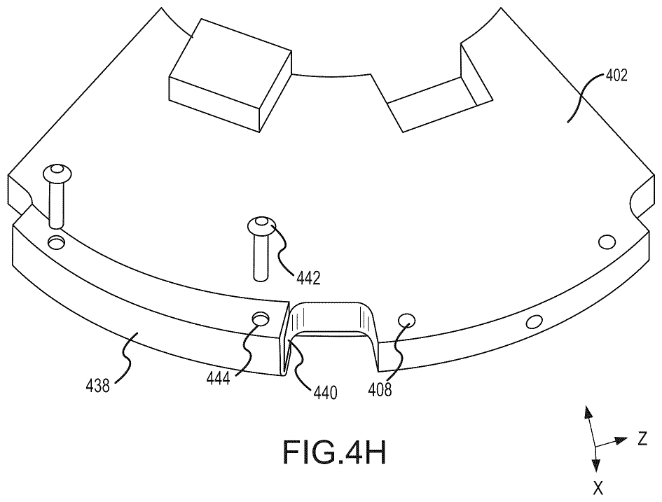

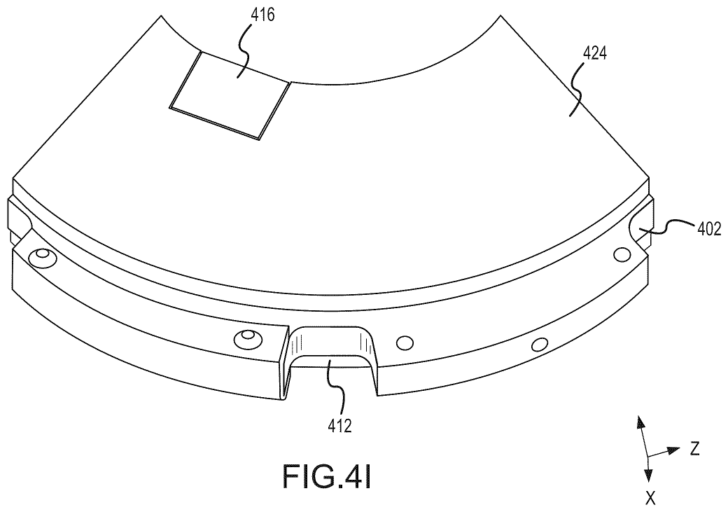

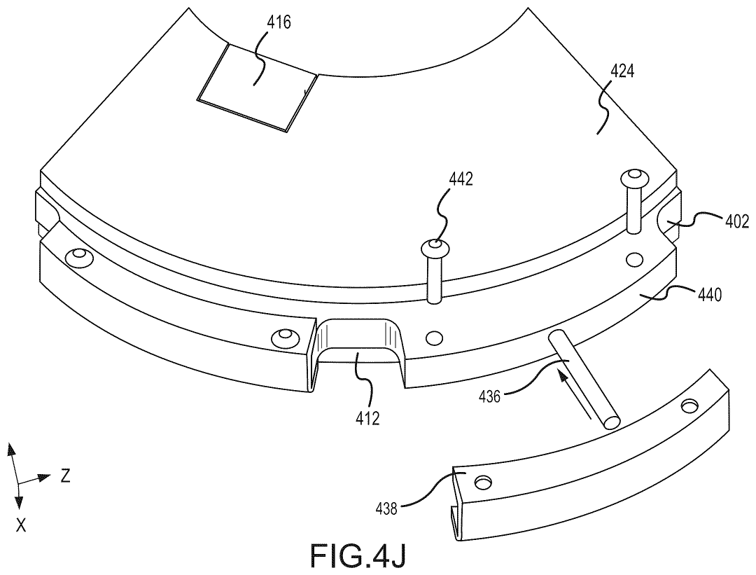

Referring now to FIGS. 4A, 4B, 4C, 4D, 4E, 4F, 4G, 4H, 4I, and 4J, in accordance with various embodiments, a view of a rotor where wear liners are coupled to the friction disk core using solid pins and lug clips is illustrated. With particular attention to FIG. 4A, in various embodiments, rotor 400 includes a friction disk core 402 that includes two faces, an inner circumferential edge, and an outer circumferential edge. In various embodiments, the friction disk core 402 includes a plurality of slots 404 on an inner diameter of the friction disk core 402, i.e. from the inner circumferential edge radially outward, a plurality of pin holes 406 between the faces of the friction disk core extending from the inner circumferential edge to the outer circumferential edge and each configured for receiving a solid pin, rivet holes 408 each configured for receiving a rivet to couple lug clips to the friction disk core 402, and a plurality of rotor slots 410 configured for engagement of the rotor with a wheel torque bar.

With particular attention to FIG. 4B, which illustrates a section of the friction disk core 402, in various embodiments, the friction disk core 402 may be a reusable component that is used as a carrier for wear liners. In various embodiments, plurality of slots 404 on an inner diameter of the friction disk core 402 are configured to provide an interface for interlocking a wear liner lug of a wear liner, described hereafter. In various embodiments, each pin hole of the plurality of pin holes 406 is configured to allow a passage for a solid pin through the friction disk core 402 an into a wear liner lug of a wear liner. With particular attention to FIG. 4C, which illustrates a section of a first wear liner 412 that includes an inner face that faces one of the faces of the friction disk core 402, an outer face, an inner circumferential edge, and an outer circumferential edge. In various embodiments, a non-wear surface 414, i.e. the inner face, of the first wear liner 416 may include a wear liner lug 416 that is a raised portion extending in a first direction perpendicular to the non-wear surface 414. In various embodiments, the wear liner lug 416 includes a hole 418 extending radially inward through a portion of the wear liner lug 416 and configured for receiving the solid pin that passes through a pin hole of the plurality of pin holes 406 in the friction disk core 402. In various embodiments, the first wear liner 412 includes a wear liner slot 420 that is configured to allow a wear liner lug from a second wear liner, described hereafter, to interlock with the friction disk core 402 and the first wear liner 412. In various embodiments, the first wear liner 412 include a wear surface 422 opposite the non-wear surface 414.

With particular attention to FIG. 4D, which illustrates a section of the second wear liner 424 that includes an inner face that faces one of the faces of the friction disk core 402, an outer face, an inner circumferential edge, and an outer circumferential edge. In various embodiments, a non-wear surface 426, i.e. the inner face, of the second wear liner 424 may include a wear liner lug 428 that is a raised portion extending in a second direction opposite the first direction perpendicular to the non-wear surface 426. In various embodiments, the wear liner lug 428 includes a hole 430 extending radially inward through a portion of the wear liner lug 428 and configured for receiving the solid pin that passes through a pin hole of the plurality of pin holes 406 in the friction disk core 402. In various embodiments, the second wear liner 424 includes a wear liner slot 432 that is configured to allow the wear liner lug 416 from the first wear liner 412, described above, to interlock with the friction disk core 402 and the second wear liner 424. In various embodiments, the second wear liner 412 include a wear surface 434 opposite the non-wear surface 426. With particular attention to FIG. 4E, which illustrates a complete view of the first wear liner 412, in various embodiments, the first wear liner 412 includes wear liner lugs 416 and wear liner slots 420.

With particular attention to FIG. 4F, in various embodiments, FIG. 4F illustrates a section of the first wear liner 412 coupled to the friction disk core 402. In various embodiments, the wear liner lug 416 protrudes though a slot of the plurality of slots 404 on the inner diameter of the friction disk core 402. In various embodiments, another slot of the plurality of slots 404 aligns with wear liner slot 420 of the first wear liner 412 to allow for the wear liner lug 428 of the second wear liner 424 to interlock with the friction disk core 402 and the first wear liner 412.

With particular attention to FIG. 4G, in various embodiments, FIG. 4G illustrates a solid pin 436 being inserted into a hole of the plurality of pin holes 406 of the friction disk core 402 and into the hole 418 of the wear liner lug 416 of the first wear liner 412. With particular attention to FIG. 4H, in various embodiments, FIG. 4H illustrates a lug clip 438 being installed over a lug 440 of the friction disk core 402. In various embodiments, the lug clip 438 may be retained via rivets 442 that protrude through holes 444 in the sides of lug clip 438 and rivet holes 408 in the friction disk core 402. In that regard, in various embodiments, the lug clip 438 may be configured to retain the solid pin 436 within the friction disk core 402 and the wear liner lug 416 of the first wear liner 412.

With particular attention to FIG. 4I, in various embodiments, FIG. 4I illustrates a section of the second wear liner 424 coupled to the friction disk core 402. In various embodiments, the wear liner lug 428 of the second wear liner 424 protrudes though a slot of the plurality of slots 404 on the inner diameter of the friction disk core 402 and through the wear liner slot 420 of the first wear liner 412 thereby interlocking the second wear liner 424 the friction disk core 402 and the first wear liner 412. In various embodiments,

With particular attention to FIG. 4J, in various embodiments, FIG. 4J illustrates a solid pin 436 being inserted into a hole of the plurality of pin holes 406 of the friction disk core 402 and into the hole 430 of the wear liner lug 428 of the second wear liner 412. FIG. 4J further illustrates a lug clip 438 being installed over a lug 440 of the friction disk core 402. In various embodiments, the lug clip 438 may be retained via rivets 442 that protrude through holes 444 in the sides of lug clip 438 and rivet holes 408 in the friction disk core 402. In that regard, in various embodiments, the lug clip 438 may be configured to retain the solid pin 436 within the friction disk core 402 and the wear liner lug 428 of the second wear liner 424.

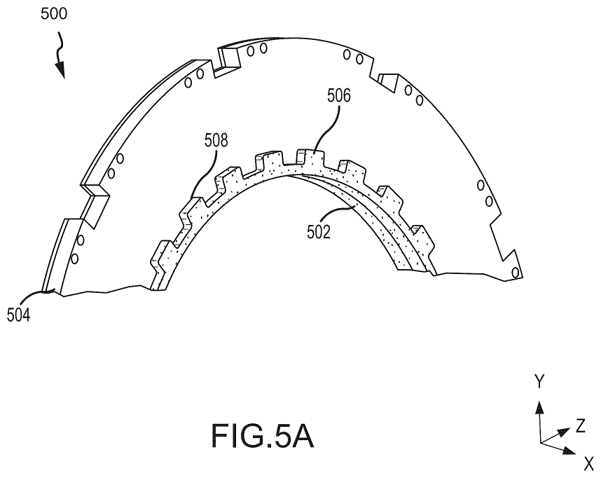

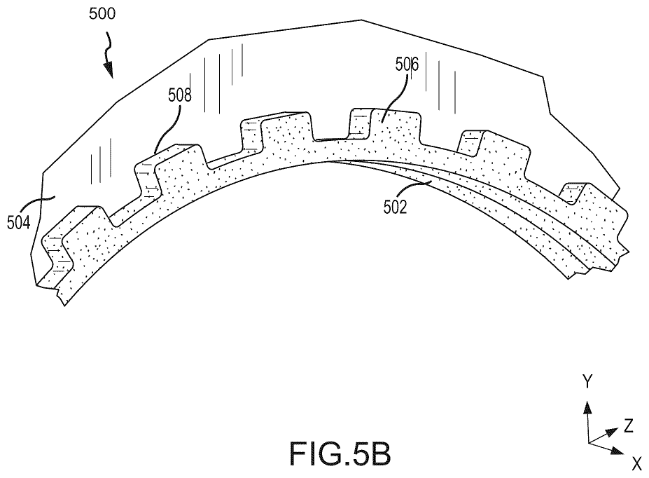

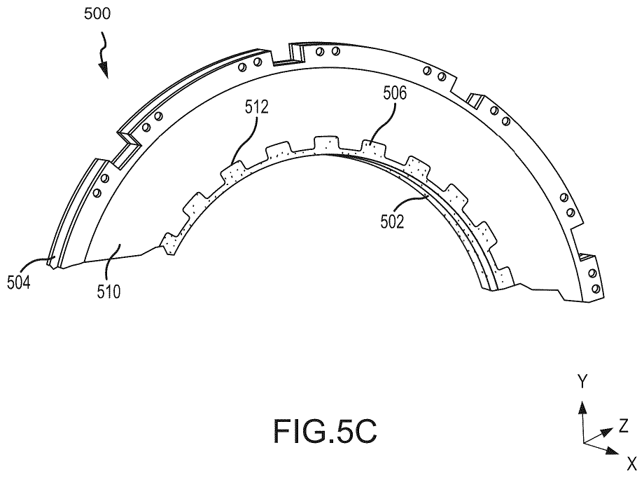

Referring now to FIGS. 5A, 5B, and 5C, in accordance with various embodiments, a portion of a rotor having a friction disk core with wear liners coupled to the friction disk core using a key ring is illustrated. In various embodiments, a key ring 502 is coupled to an inside diameter of the friction disk core 504 for rotor 500. In various embodiments, the friction disk core 504 includes two faces, an inner circumferential edge, and an outer circumferential edge. In various embodiments, the key ring 502 may be a single key ring or a set of key rings. In various embodiments, the key pins 506 on the key ring 502 protrude into a set of slots 508, i.e. voids, machined into the friction disk core 504 which are sized based on program requirements. In various embodiments, the set of slots 508 are formed from the inner circumferential edge radially outward through the full thickness of the friction disk core 504. In various embodiments, the key pins 506 on the key ring 502 extend radially outward and may have a shape, where the shape is rectangular or substantially rectangular, tapered inward, or tapered outward, among other configurations. In that regard, in various embodiments, the set of slots 508 in the friction disk core 504 may have a shape, where the shape is rectangular or substantially rectangular, tapered inward, or tapered outward, among other configurations.

In various embodiments, wear liners 510 that are coupled to the friction disk core 504 include a matching set of slots 512 that extends either through a full thickness of the wear liners 510, i.e. voids, or halfway or substantially halfway through the thickness of the wear liners 510, i.e. recesses, such that a key 516 on the key ring 502 extends through the full thickness of the friction disk core 504 and all the way through each of the wear liners 510 or only halfway or substantially halfway through the each of the wear liners 510. In various embodiments, the wear liners 510 include an inner face that faces one of the faces of the friction disk core 504, an outer face, an inner circumferential edge, and an outer circumferential edge. In various embodiments, the set of slots 512 in the wear liners 510 are formed from the inner circumferential edge radially outward. In various embodiments, the wear liners 510 may then be coupled to the friction disk core and the key ring via cast clips, half cast clips, floating clips, or lug clips, among others.

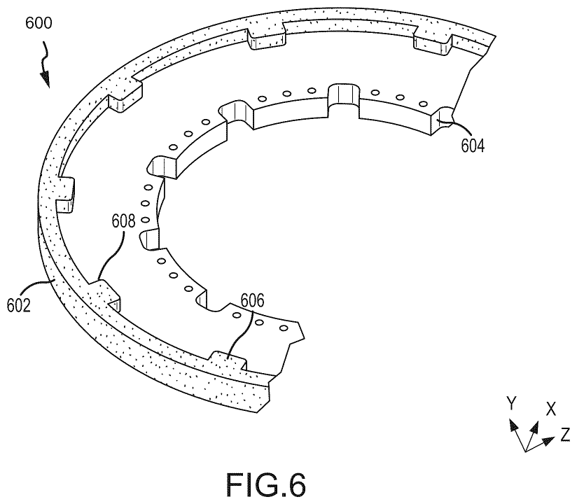

Referring now to FIG. 6, in accordance with various embodiments, a portion of a stator having a friction disk core with wear liners coupled to the friction disk core using a key ring is illustrated. In various embodiments, a key ring 602 is coupled to an outside diameter of the friction disk core 604 for stator 600. In various embodiments, the friction disk core 604 includes two faces, an inner circumferential edge, and an outer circumferential edge. In various embodiments, the key ring 602 may be a single key ring or a set of key rings. In various embodiments, the key pins 606 on the key ring 602 protrude into a set of slots 608, i.e. voids, machined into the friction disk core 604 which are sized based on program requirements. In various embodiments, the set of slots 608 are formed from the outer circumferential edge radially inward through the full thickness of the friction disk core 604. In various embodiments, the key pins 606 on the key ring 602 extend radially inward and may be rectangular or substantially rectangular, tapered inward, or tapered outward, among other configurations. In that regard, in various embodiments, the set of slots 608 in the friction disk core 604 may be rectangular or substantially rectangular, tapered inward, or tapered outward, among other configurations. In various embodiments, the set of slots 608 in the friction disk core 604 are through the full thickness of the friction disk core 604.

In various embodiments, wear liners that are coupled to the friction disk core 604 include a matching set of slots that extends either through a full thickness of the wear liners, i.e. voids, or halfway or substantially halfway through the thickness of the wear liners, i.e. recesses, such that a key pins 606 on the key ring 602 extends through the full thickness of the friction disk core 604 and all the way through each of the wear liners or only halfway or substantially halfway through the each of the wear liners. In various embodiments, the wear liners include an inner face that faces one of the faces of the friction disk core 604, an outer face, an inner circumferential edge, and an outer circumferential edge. In various embodiments, the set of slots in the wear liners are formed from an inner circumferential edge radially outward. In various embodiments, the wear liners may then be coupled to the friction disk core and the key ring via cast clips, half cast clips, floating clips, or lug clips, among others.

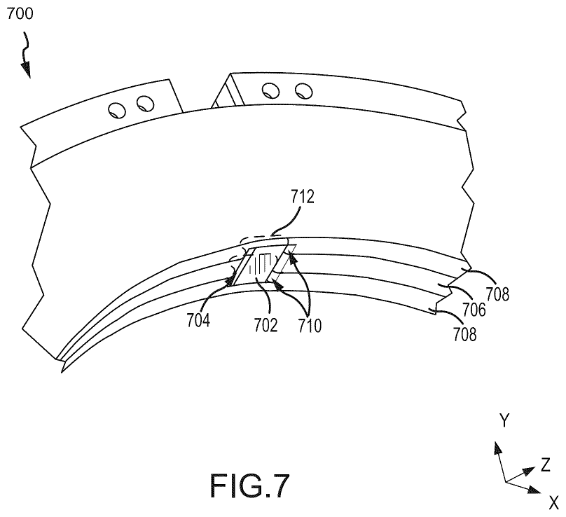

Referring now to FIG. 7, in accordance with various embodiments, a portion of a rotor having a friction disk core with wear liners coupled to the friction disk core using key pins is illustrated. In various embodiments, the friction disk core 706 includes two faces, an inner circumferential edge, and an outer circumferential edge. In various embodiments, when only key pins 702 are utilized, i.e. without the ring from FIG. 5C, the plurality of slots 704, i.e. voids, in the friction disk core 706 are through the full thickness of the friction disk core 706 and are tapered 712 so that the key pin cannot come out of the tapered slot in a radial direction. In various embodiments, the wear liners 708 include an inner face that faces one of the faces of the friction disk core 706, an outer face, an inner circumferential edge, and an outer circumferential edge. In various embodiments, when only key pins 702 are utilized, the wear liners 708 include a matching tapered slot 710 that extends halfway or substantially halfway through the thickness of the wear liners 708, thereby forming a recess, such that a key pin of the key pins 702 extends through the full thickness of the friction disk core 706 and halfway or substantially halfway through the each of the wear liners 708 and the wear liners 708 retain the key pin of the key pins 702 between the wear liners 708. In various embodiments, the wear liners 708 may then be coupled to the friction disk core 706 and retain the key pins via cast clips, half cast clips, floating clips, or lug clips, among others. In various embodiments, graphite paint may be utilized to provide lubrication in coupling the wear liners 708 to the friction disk core utilizing the key pins 702. In various embodiments, the assembled friction disk may then be air dried to cure the graphite paint and secure the key pins 702 within their respective voids and recesses.

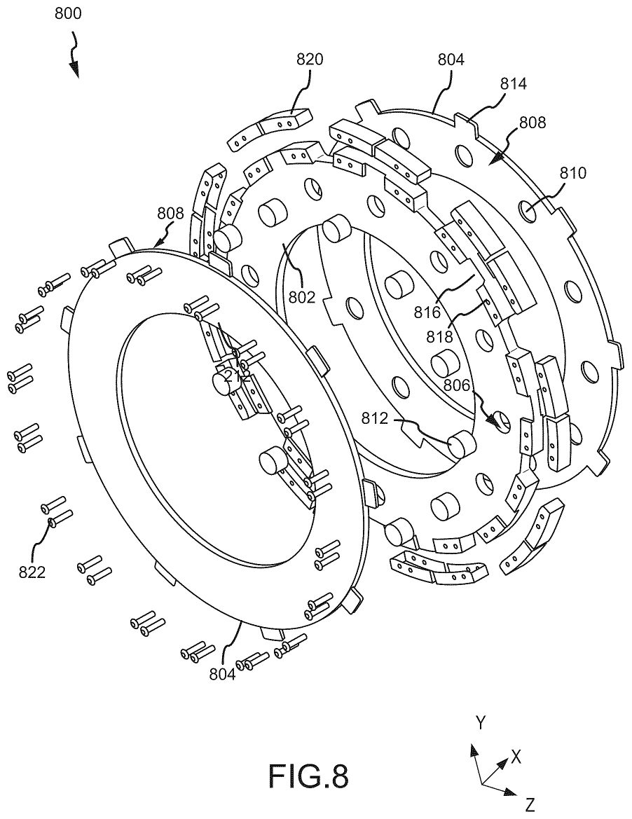

Referring now to FIG. 8, in accordance with various embodiments, an exploded view of a rotor having a friction disk core with wear liners coupled to the friction disk core utilizing a pin or puck along with tabs that that are fitted into slots in the lugs of the friction disk core is illustrated. In various embodiments, rotor 800, which may be a rotor such as a rotor of rotors 42 of FIG. 1, includes a friction disk core 802 and wear liners 804. In various embodiments, the friction disk core 802 includes two faces, an inner circumferential edge, and an outer circumferential edge. In various embodiments, each wear liner 804 includes an inner face that faces one of the faces of the friction disk core 802, an outer face, an inner circumferential edge, and an outer circumferential edge. In various embodiments, the friction disk core 802 may include cylindrical holes 806, i.e. voids, machined into the friction disk core 802 which are sized based on program requirements. In various embodiments, the cylindrical holes 806 in the friction disk core 802 are formed in an area between the inner circumferential edge and the outer circumferential edge through the full thickness of the friction disk core 802 from a first face to a second face of the faces of the friction disk core 802. In various embodiments, an inwardly facing portion 808 of the wear liners 804, i.e. a face of each of wear liners 804 facing the friction disk core 802, includes cylindrical holes 810, i.e. recesses, that extends halfway or substantially halfway through the thickness of the wear liners 804.

In various embodiments, a cylindrical pin or puck 812 extends through the cylindrical hole of the cylindrical holes 806 in the friction disk core 802 and into the cylindrical holes 810 of the wear liners 804. In various embodiments, the cylindrical pin or puck 812 may be made of a carbon/carbon material or other high temperature material that has good shear properties, such as boron carbide (B4C) or silicon carbide, among others. In various embodiments, the cylindrical pin or puck 812 may be produced in a cross laminar direction, to allow for smaller pins or pucks. In various embodiments, the wear liners 804 have plurality of tabs 814 extending radially outward from the outer edge of the wear liners 804 for rotor wear liners and on a radially inward portion of the wear liners 804 for stator wear liners. In various embodiments, the tabs 814 extend into slots 816 machined into faces of lugs 818 of the friction disk core 802.

In various embodiments, once the wear liners 804 are fitted to either side of the friction disk core 802, the wear liners 804 are fastened to the friction disk core 802 using lug clips 820 and rivets 822. In various embodiments, the lug clips 820 are placed over the lugs 818 and the tabs 814 thereby retaining the wear liners 804 in place. In various embodiments, the lug clips 820 function as washers for a riveting process, therefore spreading the load from the rivet head more effectively. In various embodiments, the lug clips 820 are affixed on an outside diameter of the rotor 800.

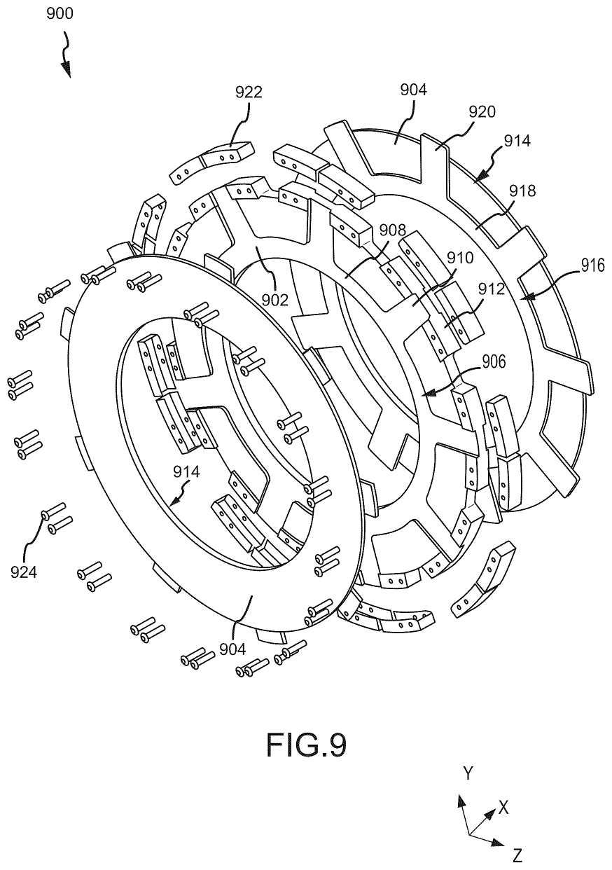

Referring now to FIG. 9, in accordance with various embodiments, an exploded view of a rotor having a friction disk core with wear liners coupled to the friction disk core utilizing boss/slot features is illustrated. In various embodiments, rotor 900, which may be a rotor such as a rotor of rotors 42 of FIG. 1, includes a friction disk core 902 and wear liners 904. In various embodiments, the friction disk core 902 includes two faces, an inner circumferential edge, and an outer circumferential edge. In various embodiments, each wear liner 904 includes an inner face that faces one of the faces of the friction disk core 902, an outer face, an inner circumferential edge, and an outer circumferential edge. In various embodiments, the friction disk core 902 may include slots 906, i.e. recesses, machined into the core which are sized based on program requirements. In various embodiments, the slots 906 may include a substantially cylindrical portion 908 formed from the inner circumferential edge radially outward with tabs 910 extending from the cylindrical portion 908 radially outward and into a center portion of faces of lugs 912 of the friction disk core 902. In that regard, in various embodiments, the slots 906 in the friction disk core 902 extend only partially into a thickness of the friction disk core 902. In various embodiments, an inwardly facing portion of the wear liners 904, i.e. a face 914 of each of the wear liners 904 facing the friction disk core 902, include an opposite feature to the slots 906 in the friction disk core 902, i.e. a boss 916, i.e. a raised portion, that is formed from the inner circumferential edge radially outward and extends halfway or substantially halfway through the thickness of each of the wear liners 904 such that bosses 916 of the wear liners 904 mate with the slots 906 in the friction disk core 902.

In various embodiments, the boss 916 may include a substantially cylindrical portion 918 formed from the inner circumferential edge extending radially outward with tabs 920 extending from the cylindrical portion 918 radially outward. In various embodiments where the brake disk is a stator, the wear liners 904 have tabs 920 extending radially outward from the cylindrical portion 918. In various embodiments, the tabs 920 fit into the tabs 910 machined into faces of the friction disk core 902. In various embodiments, once the wear liners 904 are fitted to either side of the friction disk core 902, the wear liners 904 are fastened to the friction disk core 902 using lug clips 922 and rivets 924. In various embodiments, the lug clips 922 are placed over the lugs 912 and the tabs 920 thereby retaining the wear liners 904 in place. In various embodiments, the lug clips 922 function as washers for a riveting process, therefore spreading the load from the rivet head more effectively. In various embodiments, the lug clips 922 are affixed on an outside diameter of the rotor 900.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A friction disk comprising:
a friction disk core, wherein the friction disk core comprises at least one of a void through a full thickness of the friction disk core or a first recess in a first face of the friction disk core and a second recess of a second face of the friction disk core;
a first wear liner located over a first surface of the friction disk core, wherein the first wear liner comprises a raised portion and a non-raised portion; and
a second wear liner located over a second surface of the friction disk core, wherein the second wear liner comprises a raised portion and a non-raised portion, where the raised portion of the first wear liner is configured to fit within the at least one of the void or the first recess on the first face of the friction disk core and wherein the raised portion of the second wear liner is configured to fit within the at least one of the void or the second recess on the second face of the friction disk core.

2. The friction disk of claim 1, wherein the friction disk core comprises the void, wherein the raised portion of the first wear liner mates with the raised portion of the second wear liner within the void in the friction disk core, wherein the non-raised portion of the first wear liner mates with non-void area of the first face of the friction disk core, and wherein the non-raised portion of the second wear liner mates with non-void area of the second face of the friction disk core.

3. The friction disk of claim 2, wherein the raised portion of the first wear liner that mates with the raised portion of the second wear liner within the void in the friction disk core are coupled together using a C-clip and a rivet.

4. The friction disk of claim 2, wherein the void in the friction disk core is formed from an inner circumferential edge of the friction disk core radially outward through the full thickness of the friction disk core.

5. The friction disk of claim 1, wherein the friction disk core comprises at least one first void and at least one second void, wherein the second wear liner further comprises a second wear liner void, wherein the raised portion of the first wear liner fits through the at least one first void in the friction disk core and the second wear liner void in the second wear liner, wherein the first wear liner further comprises a first wear liner void, and wherein the raised portion of the second wear liner fits through the second void in the friction disk core and the second wear liner void in the first wear liner.

6. The friction disk of claim 1, wherein the first wear liner is coupled to the friction disk core via a first solid pin that is inserted in a first pin hole between the faces of the friction disk core extending from an inner circumferential edge to an outer circumferential edge and into a first hole in the raised portion of the first wear liner and wherein the second wear liner is coupled to the friction disk core via a second solid pin that is inserted in a second pin hole between the faces of the friction disk core extending from the inner circumferential edge to the outer circumferential edge and into a second hole in the raised portion of the second wear liner.

7. The friction disk core of claim 6, wherein the first solid pin is retained within the first pin hole and the first hole in the raised portion of the first wear liner via a first lug clip and a first set of rivets and wherein the second solid pin is retained within the second pin hole and the second hole in the raised portion of the second wear liner via a second lug clip and a second set of rivets.

8. The friction disk of claim 1, wherein the friction disk core comprises the first recess in the first face of the friction disk core and the second recess of the second face of the friction disk core, wherein the raised portion of the first wear liner mates with the first recess in the first face of the friction disk core, wherein the raised portion of the second wear liner mates with the second recess in the second face of the friction disk core.

9. The friction disk of claim 8, wherein the raised portion of the first wear liner comprises a substantially cylindrical portion formed from an inner circumferential edge of the first wear liner extending radially outward and a set of first tabs extending from the cylindrical portion radially outward and wherein the raised portion of the second wear liner comprises a substantially cylindrical portion formed from an inner circumferential edge of the second wear liner extending radially outward and a set of second tabs extending from the cylindrical portion radially outward.

10. The friction disk of claim 9, wherein the first wear liner and the second wear liner are coupled to the friction disk core via a lug clip fitted over a lug of a set of lugs of the friction disk core, a tab of the set of first tabs of the first wear liner, and a tab of the set of second tabs of the second wear liner and wherein the lug is coupled to the friction disk core via a set of rivets.

11. A friction disk comprising:
a friction disk core, wherein the friction disk core comprise at least one void through a full thickness of the friction disk core;
a first wear liner located over a first surface of the friction disk core, wherein the first wear liner comprises at least one of a first void or a first recess;
a second wear liner located over a second surface of the friction disk core, wherein the second wear liner comprises at least one of a second void or a second recess; and
a component, wherein the component is configured to fit within a void of the at least one void of the friction disk core and into the at least one of the first void or the first recess of the first wear liner and into the at least one of the second void or the second recess of the second wear liner.

12. The friction disk of claim 11, wherein the component is a key ring, wherein the key ring comprises at least one key pin, and wherein the at least one key pin is configured to fit within a void of the at least one void of the friction disk core and into the at least one of the first void or the first recess of the first wear liner and into the at least one of the second void or the second recess of the second wear liner.

13. The friction disk of claim 12, wherein the at least one void of the friction disk core comprises a shape, wherein the shape is at least one of rectangular, substantially rectangular, tapered inward, or tapered outward, wherein each key pin of the at least one key pin comprises a shape, and wherein the shape is at least one of rectangular, substantially rectangular, tapered inward, or tapered outward.

14. The friction disk of claim 12, wherein the key ring is a set of key rings.

15. The friction disk of claim 11, wherein the component is a key pin, wherein the first wear liner comprises only the at least one the first recess, wherein the second wear liner comprises only the at least one second recess, and wherein the key pin is configured to fit within a void of the at least one void of the friction disk core and into the at least one first recess of the first wear liner and into the at least one second recess of the second wear liner.

16. The friction disk of claim 15, wherein the at least one void of the friction disk core comprises a shape, wherein the shape is at least one of rectangular, substantially rectangular, tapered inward, or tapered outward, wherein the key pin comprises a shape, and wherein the shape is at least one of rectangular, substantially rectangular, tapered inward, or tapered outward.

17. The friction disk of claim 15, wherein graphite paint is utilized to couple the friction disk core, the first wear liner, and the second wear liner utilizing the key pin and wherein, once assembled, the friction disk is air dried to cure the graphite paint and secure the key pin to the friction disk core, the first wear liner, and the second wear liner.

18. The friction disk of claim 11, wherein the at least one void is machined through the full thickness of the friction disk core in an area between an inner circumferential edge and an outer circumferential edge of the friction disk core, wherein the component is at least one of a pin or a puck, and wherein the pin or the puck of the at least one of the pin or the puck is configured to fit within a void of the at least one void of the friction disk core and into the first recess of the at least one first recess of the first wear liner and into a second recess of the second recess of the second wear liner.

19. The friction disk of claim 18, wherein the least one void of the friction disk core is substantially cylindrical, wherein the first recess of the at least one first recess of the first wear liner is substantially cylindrical, wherein the second recess of the second recess of the second wear liner is substantially cylindrical, and wherein pin or puck is substantially cylindrical.

20. The friction disk of claim 9, wherein the first wear liner comprises a first plurality of tabs extend radially outward from an outer edge of the first wear liner, wherein the second wear liner comprises a second plurality of tabs extend radially outward from an outer edge of the second wear liner, wherein the first wear liner and the second wear liner are coupled to the friction disk core via a lug clip fitted over a lug of a set of lugs of the friction disk core, a tab of the first plurality of tabs of the first wear liner, and a tab of the second plurality of tabs of the second wear liner, and wherein the lug is coupled to the friction disk core via a set of rivets.
